(19) United States
(12) Patent Application Publication
(10) Pub. No.: US 2016/0369206 A1
(43) Pub. Date: Dec. 22, 2016

(54) LOW SOLVENT LIQUID DETERGENT COMPOSITIONS

(71) Applicant: The Procter & Gamble Company, Cincinnati, OH (US)

(72) Inventors: Kristof CRETS, Buggenhout (BE); Bill Karel MAHIEU, Brussels (BE)

(21) Appl. No.: 15/187,815

(22) Filed: Jun. 21, 2016

(30) Foreign Application Priority Data
Jun. 22, 2015 (EP) 15173055.3

(51) Int. Cl. C11D 1/83; C11D 1/62; C11D 11/00

(52) U.S. Cl. CPC C11D 1/83; C11D 11/0017; C11D 1/62

(57) ABSTRACT

Liquid detergent composition which comprises an effective cleaning amount of surfactant, while still being pleasingly free-flowing, and which does not require high levels of organic, non-aminofunctional solvents in order to control the viscosity, can be formulated using a zwitterion, especially a zwitterionic polyamine.

### FIELD OF THE INVENTION

Low solvent liquid detergent compositions.

### BACKGROUND OF THE INVENTION

In order to provide good cleaning, liquid detergent compositions typically comprise appreciable amounts of cleaning surfactants, with the result that at least part of the surfactant system is present in the worm-like phase or liquid crystalline phase. When there is sufficient surfactant to form micelles (concentrations above the critical micelle concentration or CMC), for example, spherical, cylindrical (rod-like) or discoidal micelles may form. As surfactant concentration increases, a wormlike micellar phase is formed. At higher surfactant concenrations, a liquid crystalline phase, such as lamellar phase, hexagonal phase or cubic phase may form. The lamellar phase, for example, consists of alternating surfactant bilayers and water layers. These layers are not generally flat but fold to form submicron spherical onion like structures called vesicles or liposomes. The hexagonal phase, on the other hand, consists of long cylindrical micelles arranged in a hexagonal lattice. Such worm-like micellar and liquid crystalline phases can result in excessive viscosities and lumpiness, in addition to residue on bottle openings and also in the washing machine dispense.

As a result, organic, non-aminofunctional solvents or hydrotropes are typically added, which disrupt the phase behavior in order to lower the viscosity, and to reduce lumpiness. However, such organic, non-aminofunctional solvents and hydrotropes add to the cost of the formulation, while providing limited cleaning benefit.

Hence, a need remains for a liquid detergent composition which comprises an effective cleaning amount of surfactant, while still being pleasingly free-flowing, and which does not require high levels of organic, non-aminofunctional solvents in order to control the viscosity.

EP1220886 relates to liquid cleansing compositions in lamellar phase with low level of strong electrolyte.

### SUMMARY OF THE INVENTION

The present invention relates to a liquid detergent composition comprising: a cleaning surfactant selected from the group consisting of: anionic surfactant, non-ionic surfactant, and mixtures thereof; a zwitterion; and less than 2 wt % of organic, non-aminofunctional solvent.

The present invention further relates to the use of a zwitterion for reducing the viscosity of a liquid detergent composition which comprises a worm-like micellar phase, or a liquid crystalline phase.

### DETAILED DESCRIPTION OF THE INVENTION

By incorporating a zwitterion into the liquid detergent composition, a liquid detergent composition which comprises an effective cleaning amount of surfactant, while still being pleasingly free-flowing, and which does not require high levels of organic, non-aminofunctional solvents in order to control the viscosity, can be provided. Moreover, a liquid detergent composition can be formulated which has a lower flash point.

As used herein, “liquid laundry detergent composition” refers to any laundry treatment composition comprising a fluid capable of wetting and cleaning fabric e.g., clothing, in a domestic washing machine. The composition can include solids or gases in suitably subdivided form, but the overall composition excludes product forms which are nonfluid overall, such as tablets or granules. The compact fluid detergent compositions preferably have densities in the range from 0.9 to 1.3 grams per cubic centimeter, more specifically from 1.00 to 1.10 grams per cubic centimeter, excluding any solid additives but including any bubbles, if present.

As used herein, the term “external structuring system” refers to a selected compound or mixture of compounds which provide either a sufficient yield stress or low shear viscosity to stabilize the liquid laundry detergent composition independently from, or extrinsic from, any structuring effect of the detersive surfactants of the composition. By “internal structuring” it is meant that the detergent surfactants, which form a major class of laundering ingredients, are relied on for providing the necessary yield stress or low shear viscosity.

All percentages, ratios and proportions used herein are by weight percent of the composition, unless otherwise specified. All average values are calculated “by weight” of the composition or components thereof, unless otherwise expressly indicated.

### Liquid Detergent Composition:

The liquid detergent composition comprises a cleaning surfactant selected from the group consisting of: anionic surfactant, non-ionic surfactant, and mixtures thereof; a zwitterion; and less than 2 wt % of organic, non-aminofunctional solvent.

The liquid detergent composition can comprise the cleaning surfactant at a level of from 1 wt % to 70 wt %, preferably from 10 wt % to 40 wt %, more preferably from 15 wt % to 30 wt %.

The cleaning surfactant typically comprises anionic surfactant. In preferred liquid detergent compositions, the cleaning surfactant can comprise the anionic surfactant at a level of from 1 wt % to 50 wt %, preferably from 10 wt % to 40 wt %, more preferably from 15 wt % to 30 wt %.

Suitable anionic surfactants can be selected from the group consisting of: alkyl sulphates, alkyl ethoxy sulphates, alkyl sulphonates, alkyl benzene sulphonates, fatty acids and their salts, and mixtures thereof. However, by nature, every anionic surfactant known in the art of detergent compositions may be used, such as disclosed in “Surfactant Science Series”, Vol. 7, edited by W. M. Linfield, Marcel Dekker. However, the base mix preferably comprises at least a sulphonic acid surfactant, such as a linear alkyl benzene sulphonic acid, but water-soluble salt forms may also be used. Anionic surfactant(s) are typically present at a level of from 1.0% to 70%, preferably from 5.0% to 50% by weight, and more preferably from 10% to 30% by weight of the base mix.

Anionic sulfonate or sulfonic acid surfactants suitable for use herein include the acid and salt forms of linear or branched C5-C20, more preferably C10-C16, more preferably C11-C13 alkylbenzene sulfonates, C5-C20 alkyl ester sulfonates, C6-C22 primary or secondary alkane sulfonates, C5-C20 sulfonated polycarboxylic acids, and any mixtures thereof, but preferably C11-C13 alkylbenzene sulfonates. The aforementioned surfactants can vary widely in their 2-phenyl isomer content.

Anionic sulphate salts suitable for use in the compositions of the invention include the primary and secondary alkyl sulphates, having a linear or branched alkyl or alkenyl moiety having from 9 to 22 carbon atoms or more preferably 12 to 18 carbon atoms. Also useful are beta-branched alkyl sulphate surfactants or mixtures of commercial available materials, having a weight average (of the surfactant or the mixture) branching degree of at least 50%.

Mid-chain branched alkyl sulphates or sulfonates are also suitable anionic surfactants for use in the compositions of the invention. Preferred are the C5-C22, preferably C10-C20 mid-chain branched alkyl primary sulphates. When mixtures are used, a suitable average total number of carbon atoms for the alkyl moieties is preferably within the range of from greater than 14.5 to 17.5. Preferred mono-methyl-branched primary alkyl sulphates are selected from the group consisting of the 3-methyl to 13-methyl pentadecanol sulphates, the corresponding hexadecanol sulphates, and mixtures thereof. Dimethyl derivatives or other biodegradable alkyl sulphates having light branching can similarly be used.

Other suitable anionic surfactants for use herein include fatty methyl ester sulphonates and/or alkyl alkoxylated sulphates such as alkyl ethyoxy sulphates (AES) and/or alkyl polyalkoxylated carboxylates (AEC).

The anionic surfactants are typically present in the form of their salts with alkanolamines or alkali metals such as sodium and potassium.

For improved stability, the liquid detergent composition can comprise linear alkyl benzene sulfonate surfactant and alkyl alkoxylated sulphate surfactant, such that the ratio of linear alkyl benzene sulfonate surfactant is from 0.1 to 5, preferably from 0.25 to 3, more preferably from 0.75 to 1.5. When used, the alkyl alkoxylated sulphate surfactant is preferably a blend of one or more alkyl ethoxylated sulphates, more preferably having a degree of ethoxylation of from 1 to 10, most preferably from 1.8 to 4.

The liquid detergent composition can comprise nonionic surfactant. The level of nonionic surfactant in the liquid detergent composition can be present at a level of less than 10 wt %, preferably less than 5 wt %, more preferably less than 1 wt %, most preferably less than 0.5 wt %.

Suitable nonionic surfactants include, but are not limited to C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e.g., amine oxides and phosphine oxides) can be used in the present compositions. An extensive disclosure of these types of surfactants is found in U.S. Pat. No. 3,929,678, Laughlin et al., issued Dec. 30, 1975.

Alkylpolysaccharides such as disclosed in U.S. Pat. No. 4,565,647 Llenado are also useful nonionic surfactants in the compositions of the invention.

Also suitable are alkyl polyglucoside surfactants.

In some embodiments, nonionic surfactants of use include those of the formula R₁(OC₂H₄)ₙOH, wherein R₁ is a C10-C16 alkyl group or a C8-C12 alkyl phenyl group, and n is from preferably 3 to 80. In some embodiments, the nonionic surfactants may be condensation products of C12-C15 alcohols with from 5 to 20 moles of ethylene oxide per mole of alcohol, e.g., C12-C13 alcohol condensed with 6.5 moles of ethylene oxide per mole of alcohol

Additional suitable nonionic surfactants include polyhydroxy fatty acid amides of the formula:

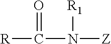

wherein R is a C9-17 alkyl or alkenyl, R1 is a methyl group and Z is glycidyl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in Wilson, U.S. Pat. No. 2,965,576 and Schwartz, U.S. Pat. No. 2,703,798.

The liquid detergent composition comprises a zwitterion. Even low levels of the zwitterion have been found to improve the stability of liquid detergent compositions which comprise little or no organic, non-aminofunctional solvent. The zwitterion can be present at a level of from 0.1 wt % to 5 wt %, preferably from 0.2 wt % to 2 wt %, more preferably from 0.4 wt % to 1 wt %.

Zwitterionic detersive surfactants include those which are known for use in hair care or other personal care cleansing. Non-limiting examples of suitable zwitterions are described in U.S. Pat. No. 5,104,646 (Bolich Jr. et al.), U.S. Pat. No. 5,106,609 (Bolich Jr. et al.). Zwitterionic detersive surfactants are well known in the art, and include those surfactants broadly described as derivatives of aliphatic quaternary ammonium, phosphonium, and sulfonium compounds, in which the aliphatic radicals can be straight or branched chain, and wherein one of the aliphatic substituents contains from 8 to 18 carbon atoms and one contains an anionic group such as carboxy, sulfonate, sulfate, phosphate or phosphonate. Betaines are also suitable zwitterinic surfactants.

Particularly preferred zwitterions are zwitterionic polyamines. Suitable zwitterionic polymers can be comprised of a polyamine backbone wherein the backbone units which connect the amino units can be modified by the formulator to achieve varying levels of product enhancement, inter alia, boosting of clay soil removal by surfactants, greater effectiveness in high soil loading usage. In addition to modification of the backbone compositions, the formulator may preferably substitute one or more of the backbone amino unit hydrogens by other units, inter alia, alkyleneoxy units having a terminal anionic moiety. In addition, the nitrogens of the backbone may be oxidized to the N-oxide. Preferably at least two of the nitrogens of the polyamine backbones are quaternized.

“Cationic units” are defined as “units which are capable of having a positive charge”. The cationic units are the quaternary ammonium nitrogens of the polyamine backbones. “Anionic units” are defined as “units which are capable of having a negative charge”. Anionic units are “units which alone, or as a part of another unit, substitute for hydrogen atoms of the backbone nitrogens along the polyamine backbone” a non-limiting example of which is a —(CH₂CH₂O)₂₀SO₃Na which is capable of replacing a backbone hydrogen on a nitrogen atom.

Suitable zwitterionic polyamines have the formula:

[J-R]ₙ-J

wherein the [J-R] units represent the amino units which comprise the main backbone and any branching chains. Preferably the zwitterionic polyamines prior to modification, inter alia, quaternization, substitution of a backbone unit hydrogen with an alkyleneoxy unit, have backbones which comprise from 2 to about 100 amino units. The index n which describes the number of backbone units present is further described herein below.

J units are the backbone amino units, said units are selected from the group consisting of:
i) primary amino units having the formula:

(R¹)₂N;
ii) secondary amino units having the formula:

—R¹N_{;}
iii) tertiary amino units having the formula:

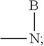

iv) primary quaternary amino units having the formula:

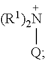

v) secondary quaternary amino units having the formula:

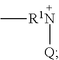

vi) tertiary quaternary amino units having the formula:

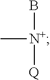

vii) primary N-oxide amino units having the formula:

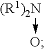

viii) secondary N-oxide amino units having the formula:

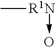

ix) tertiary N-oxide amino units having the formula:

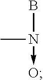

x) and mixtures thereof.
B units which have the formula:

[J-R]—

represent a continuation of the zwitterionic polyamine backbone by branching. The number of B units present, as well as, any further amino units which comprise the branches are reflected in the total value of the index n.

The backbone amino units of the zwitterionic polymers are connected by one or more R units, said R units are selected from the group consisting of:
i) C₂-C₁₂ linear alkylene, C₃-C₁₂ branched alkylene, or mixtures thereof; preferably C₃-C₆ alkylene. When two adjacent nitrogens of the polyamine backbone are N-oxides, preferably the alkylene backbone unit which separates said units are C₄ units or greater.
ii) alkyleneoxyalkylene units having the formula:

—(R²O)_{w}(R³)—
wherein R² is selected from the group consisting of ethylene, 1,2-propylene, 1,3-propylene, 1,2-butylene, 1,4-butylene, and mixtures thereof; R³ is C₂-C₈ linear alkylene, C₃-C₈ branched alkylene, phenylene, substituted phenylene, and mixtures thereof; the index w is from 0 to about 25. R² and R³ units may also comprise other backbone units. When comprising alkyleneoxyalkylene units R² and R³ units are preferably mixtures of ethylene, propylene and butylene and the index w is from 1, preferably from about 2 to about 10, preferably to about 6.
iii) hydroxyalkylene units having the formula:

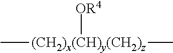

wherein R⁴ is hydrogen, C₁-C₄ alkyl, —(R²O)ₜY, and mixtures thereof. When R units comprise hydroxyalkylene units, R⁴ is preferably hydrogen or —(R²O)ₜY wherein the index t is greater than 0, preferably from 10 to 30, and Y is hydrogen or an anionic unit, preferably —SO₃M. The indices x, y, and z are each independently from 1 to 6, preferably the indices are each equal to 1 and R⁴ is hydrogen (2-hydroxypropylene unit) or (R²O)ₜY, or for polyhydroxy units y is preferably 2 or 3. A preferred hydroxyalkylene unit is the 2-hydroxypropylene unit which can, for example, be suitably formed from glycidyl ether forming reagents, inter alia, epihalohydrin.
iv) hydroxyalkylene/oxyalkylene units having the formula:

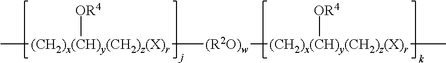

wherein R², R⁴, and the indices w, x, y, and z are the same as defined herein above. X is oxygen or the amino unit —NR⁴—, the index r is 0 or 1. The indices j and k are each independently from 1 to 20. When alkyleneoxy units are absent the index w is 0. Non-limiting examples of preferred hydroxyalkylene/oxyalkylene units have the formula:

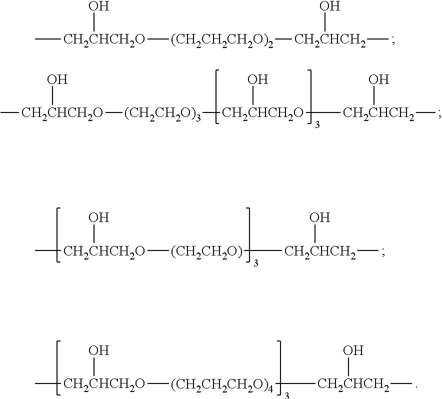

v) carboxyalkyleneoxy units having the formula:

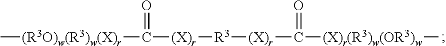

wherein R², R³, X, r, and w are the same as defined herein above. Non-limiting examples of preferred carboxyalkyleneoxy units include:

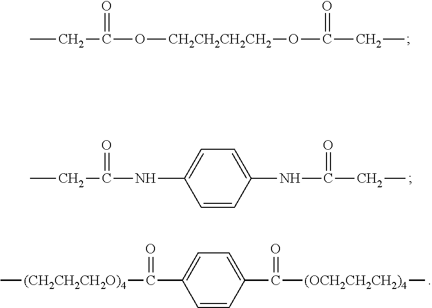

vi) backbone branching units having the formula:

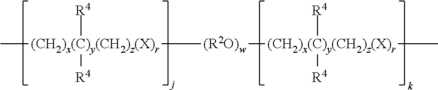

wherein R⁴ is hydrogen, C₁-C₆ alkyl, —(CH₂)ᵤ(R²O)ₜ(CH₂)ᵤY, and mixtures thereof. When R units comprise backbone branching units, R⁴ is preferably hydrogen or —(CH₂)—(R²O)ₜ—(CH₂)ᵤY wherein the index t is greater than 0, preferably from 10 to 30; the index u is from 0 to 6; and Y is hydrogen, C₁-C₄ linear alkyl, —N(R¹)₂, an anionic unit, and mixtures thereof; preferably Y is hydrogen, or —N(R¹)₂. A preferred embodiment of backbone branching units comprises R⁴ equal to —(R²O)ₜH. The indices x, y, and z are each independently from 0 to 6.
vii) The formulator may suitably combine any of the above described R units to make a zwitterionic polyamine having a greater or lesser degree of hydrophilic character.

R¹ units are the units which are attached to the backbone nitrogens. R¹ units are selected from the group consisting of:
i) hydrogen; which is the unit typically present prior to any backbone modification.
ii) C₁-C₂₂ alkyl, preferably C₁-C₄ alkyl, more preferably methyl or ethyl, most preferably methyl. In a preferred embodiment, the R¹ units are attached to quaternary units (iv) or (v), R¹ is the same unit as quaternizing unit Q. For example a J unit having the formula:

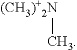

iii) C₇-C₂₂ arylalkyl, preferably benzyl.
iv) —[CH₂CH(OR⁴)CH₂O]ₛ(R²O)ₜY; wherein R² and R⁴ are the same as defined herein above, preferably when R¹ units comprise R² units, R² is preferably ethylene. The value of the index s is from 0 to 5. The index t is expressed as an average value, said average value from about 0.5 to about 100. The formulator may lightly alkyleneoxylate the backbone nitrogens in a manner wherein not every nitrogen atom comprises an R¹ unit which is an alkyleneoxy unit thereby rendering the value of the index t less than 1.
v) Anionic units as described herein below.
vi) The formulator may suitably combine one or more of the above described R¹ units when substituting the backbone of the zwitterionic polymers.

Q is a quaternizing unit selected from the group consisting of C₁-C₄ linear alkyl, benzyl, and mixtures thereof, preferably methyl. As described herein above, preferably Q is the same as R¹ when R¹ comprises an alkyl unit. For each backbone N⁺ unit (quaternary nitrogen) there will be an anion to provide charge neutrality. The anionic groups include both units which are covalently attached to the polymer, as well as, external anions which are present to achieve charge neutrality. Non-limiting examples of anions suitable for use include halogen, inter alia, chloride; methyl sulfate; hydrogen sulfate, and sulfate. The formulator will recognize by the herein described examples that the anion will typically be a unit which is part of the quaternizing reagent, inter alia, methyl chloride, dimethyl sulfate, benzyl bromide.

X is oxygen, —NR⁴—, and mixtures thereof, preferably oxygen.

Y is hydrogen, or an anionic unit. Anionic units are defined herein as “units or moieties which are capable of having a negative charge”. For example, a carboxylic acid unit, —CO₂H, is neutral, however upon de-protonation the unit becomes an anionic unit, —CO₂⁻, the unit is therefore, “capable of having a negative charge. Non-limiting examples of anionic Y units include —(CH₂)_{f}CO₂M, —C(O)(CH₂)_{f}CO₂M, —(CH₂)_{f}PO₃M, —(CH₂)_{f}OPO₃M, —(CH₂)_{f}SO₃M, —(CH₂)_{f}OSO₃M, —CH₂(CHSO₃M)(CH₂)_{f}SO₃M, —CH₂(CHSO₂M)(CH₂)_{f}OSO₃M, —CH₂(CHOSO₃M)(CH₂)_{f}OSO₃M, —CH₂(CHSO₂M)(CH₂)_{f}SO₃M, —C(O)CH₂CH(SO₃M)-CO₂M, —C(O)CH₂CH(CO₂M)NHCH(CO₂M)CH₂CO₂M, —C(O)CH₂CH(CO₂M)NHCH₂CO₂M, —CH₂CH(OZ)CH₂O(R¹O)ₜZ, —(CH₂)_{f}CH[O(R²O)ₜZ]—CH_{f}O(R²O)ₜZ, and mixtures thereof, wherein Z is hydrogen or an anionic unit non-limiting examples of which include —(CH₂)_{f}CO₂M, —C(O)(CH₂)_{f}CO₂M, —(CH₂)_{f}PO₃M, —(CH₂)_{f}OPO₃M, —(CH₂)_{f}SO₃M, —CH₂(CHSO₃M)(CH₂)_{f}SO₃M, —CH₂(CHSO₂M)(CH₂)_{f}SO₃M, —C(O)CH₂CH(SO₃M)CO₂M, —(CH₂)_{f}OSO₃M, —CH₂(CHOSO₃M)(CH₂)_{f}OSO₃M, —CH₂(CHOSO₂M)(CH₂)_{f}OSO₃M, —C(O)CH₂CH(CO₂M)NHCH(CO₂M)CH₂CO₂M, and mixtures thereof, M is a cation which provides charge neutrality.

Y units may also be oligomeric or polymeric, for example, the anionic Y unit having the formula:

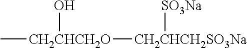

may be oligomerized or polymerized to form units having the general formula:

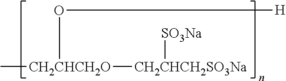

wherein the index n represents a number greater than 1.

Further non-limiting examples of Y units which can be suitably oligomerized or polymerized include:

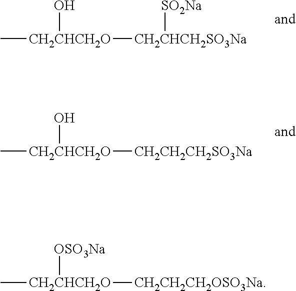

As described herein above that a variety of factors, inter alia, the overall polymer structure, the nature of the formulation, the wash conditions, and the intended target cleaning benefit, all can influence the formulator's optimal values for Qᵣ, ΔQ, and Q(+). For liquid laundry detergent compositions preferably less than about 90%, more preferably less than 75%, yet more preferably less than 50%, most preferably less than 40% of said Y units comprise an anionic moiety, inter alia, —SO₃M comprising units. The number of Y units which comprise an anionic unit will vary from embodiment to embodiment. M is hydrogen, a water soluble cation, and mixtures thereof; the index f is from 0 to 6

The index n represents the number of backbone units wherein the number of amino units in the backbone is equal to n+1. The index n is from 1 to about 99. Branching units B are included in the total number of backbone units. For example, a backbone having the formula:

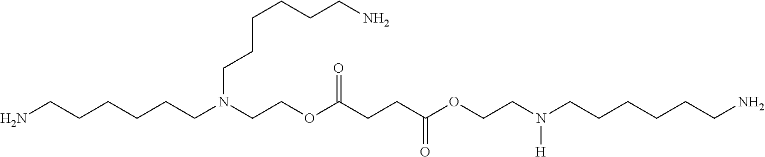 [SMILES: NCCCCCCNCCOC(=O)CCC(=O)OCCN(CCCCCCN)CCCCCCN]

has an index n equal to 4. The following is a non-limiting example of a polyamine backbone which is fully quaternized.

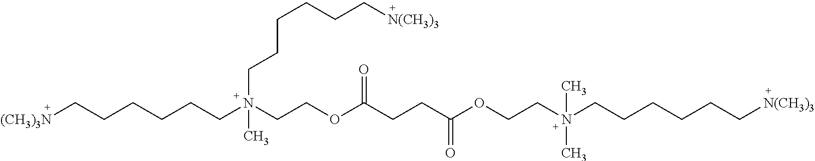

The following is a non-limiting example of a zwitterionic polyamine according to the present invention.

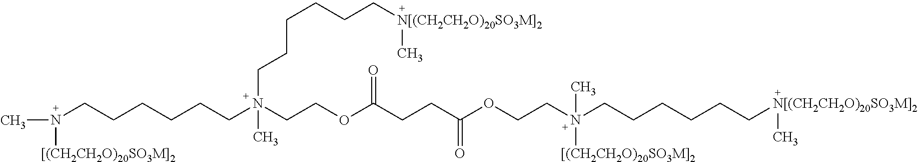

Preferred zwitterionic polymers have the formula:

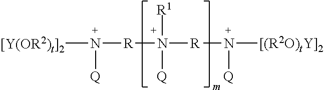

wherein R units have the formula —(R²O)_{w}R³— wherein R² and R³ are each independently selected from the group consisting of C₂-C₈ linear alkylene, C₃-C₈ branched alkylene, phenylene, substituted phenylene, and mixtures thereof. The R² units of the formula above, which comprise —(R²O)ₜY units, are each ethylene; Y is hydrogen, —SO₃M, and mixtures thereof, the index t is from 15 to 25; the index m is from 0 to 20, preferably from 0 to 10, more preferably from 0 to 4, yet more preferably from 0 to 3, most preferably from 0 to 2; the index w is from 1, preferably from about 2 to about 10, preferably to about 6. The zwitterionic polymers preferably comprise polyamine backbone which are derivatives of two types of backbone units:
i) normal oligomers which comprise R units of type (i), which are preferably polyamines having the formula:

H₂N—(CH₂)ₓ]ₙ₊₁—[NH—(CH₂)ₓ]ₘ—[NB—(CH₂)ₓ]ₙ—NH₂
wherein B is a continuation of the polyamine chain by branching, n is preferably 0, m is from 0 to 3, x is 2 to 8, preferably from 3 to 6; and
ii) hydrophilic oligomers which comprise R units of type (ii), which are preferably polyamines having the formula:

H₂N—[(CH₂)ₓO]_{y}(CH₂)ₓ]—[NH—[(CH₂)ₓO]_{y}(CH₂)ₓ]ₘ—NH₂
wherein m is from 0 to 3; each x is independently from 2 to 8, preferably from 2 to 6; y is preferably from 1 to 8.

Preferred backbone units are the units from (i). Further preferred embodiments are polyamines which comprise units from (i) which are combined with R units of types (iii), (iv), and (v), an non-limiting example of which includes the epihalohydrin condensate having the formula:

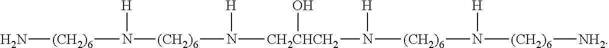

As described herein before, the formulator may form zwitterionic polymers which have an excess of charge or an equivalent amount of charge type. An example of a preferred zwitterionic polyamine according to the present invention which has an excess of backbone quaternized units, has the formula:

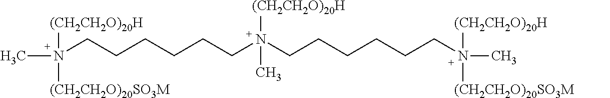

wherein R is a 1,5-hexamethylene, w is 2; R¹ is —(R²O)ₜY, wherein R² is ethylene, Y is hydrogen or —SO₃M, Q is methyl, m is 1, t is 20. For suitable zwitterionic polyamines, it will be recognized by the formulator that not every R¹ unit will have a —SO₃ moiety capping said R¹ unit. For the above example, the final zwitterionic polyamine mixture comprises at least about 40% Y units which are —SO₃ units. The zwitterion can be used for reducing the viscosity of a liquid detergent composition which comprises a worm-like micellar phase, or a liquid crystalline phase.

The liquid detergent composition can comprise less than 2 wt %, preferably less than 1.5 wt %, more preferably less than 1.0 wt %, most preferably less than 0.5 wt % of organic, non-aminofunctional solvent. As used herein, “non-aminofunctional organic solvent” refers to any solvent which contains no amino functional groups, indeed contains no nitrogen. Non-aminofunctional solvent include, for example: C1-C5 alkanols such as methanol, ethanol and/or propanol and/or 1-ethoxypentanol; C2-C6 diols; C3-C8 alkylene glycols; C3-C8 alkylene glycol mono lower alkyl ethers; glycol dialkyl ether; lower molecular weight polyethylene glycols; C3-C9 triols such as glycerol; and mixtures thereof. More specifically non-aminofunctional solvent are liquids at ambient temperature and pressure (i.e. 21° C. and 1 atmosphere), and comprise carbon, hydrogen and oxygen.

If used, highly preferred are mixtures of organic non-aminofunctional solvents, especially mixtures of lower aliphatic alcohols such as propanol, butanol, isopropanol, and/or diols such as 1,2-propanediol or 1,3-propanediol; glycerol; diethylene glycol; or mixtures thereof. Preferred is propanediol (especially 1,2-propanediol), or mixtures of propanediol with diethylene glycol. Preferred base mixes comprise less than 2.5 wt %, preferably less than 1.5 wt %, more preferably less than 1 wt % of methanol or ethanol.

High levels of volatile alcohols have a great impact on the flammability of the composition, especially for liquid compositions. Flammable materials can be categorised according to their closed cup flash point (CCFP) and boiling point, using the following National Fire Protection Association (NFPA) classification:
Class IA—CCFP of less than 73° F. (23° C.) and a boiling point of less than 100° F. (38° C.);
Class IB—CCFP of less than 73° F. (23° C.) and a boiling point of greater than 100° F. (38° C.);
Class IC—CCFP of greater than 73° F. (23° C.) but less than 100° F. (38° C.);
Class II—CCFP is at or above 100° F. (38° C.) but below 140° F. (60° C.);
Class IIIA—CCFP is at or above 140° F. (60° C.) but below 200° F. (93° C.);
Class IIIB—CCFP is at or above 200° F. (93° C.).

The flammability is measured according to the Pensky Martens closed cup flash point (CCFP) test, described in ASTM D93.

Depending on the classification, the requirements for safe handling and storage of the liquid detergent composition changes, including the requirements related to storage location and temperature control. As such, the base mix preferably has an NFPA classification of IC, preferably II, more preferably IIIA, most preferably IIIB.

Suitable liquid detergent composition can comprise less than 0.8 wt %, preferably less than 0.5 wt %, more preferably less than 0.1 wt of an organic, non-aminofunctional solvent having a closed cup flash point (CCFP) of less than 60° C., preferably less than 38° C., more preferably less than 23° C., measured according to the Pensky Martens closed cup flash point (CCFP) test, described in ASTM D93.

Suitable liquid detergent composition can comprises less than 1 wt %, preferably less than 0.75 wt %, more preferably less than 0.5 wt %, most preferably less than 0.1 wt % of a hydrotrope. Suitable hydrotropes include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. For the avoidance of doubt, hydrotropes, which are also zwitterions, are considered as zwitterions for compositions of the present invention.

The liquid detergent composition can comprise a non-surfactant salt selected from the group consisting of: sodium carbonate, sodium hydrogen carbonate (sodium bicarbonate), magnesium chloride, ethylenediaminetetraacetic acid (EDTA), diethylene triamine pentaacetic acid (DTPA), hydroxyethane diphosphonic acid (HEDP), sodium citrate, sodium chloride, citric acid, calcium chloride, sodium formate, Diethylene triamine penta methylene phosphonic acid, and mixtures thereof. Such non-surfactant salts can be used to increase the amount of liquid crystalline phase present, especially lamellar phase. The non-surfactant salt can be added to provide a level of from 1.5 wt % to 10 wt %, more preferably 2.5 wt % to 7 wt %, most preferably from 3 wt % to 5 wt % of non-surfactant salt in the liquid detergent composition.

The liquid detergent composition preferably comprises from 15% to 85%, preferably from 5% to 70%, more preferably from 10% to 60% of the liquid crystalline phase.

The liquid detergent composition preferably comprises water. The water content can be present at a level of from 10% to 90%, preferably from 25% to 80%, more preferably from 45% to 70% by weight of the liquid detergent composition.

The liquid detergent composition can comprise additional ingredients, such as those selected from the group consisting of: polymer deposition aid, organic builder and/or chelant, enzymes, enzyme stabiliser, optical brighteners, hueing dyes, particulate material, cleaning polymers, external structurants, and mixtures thereof.

Polymer Deposition Aid: The base mix can comprise from 0.1% to 7%, more preferably from 0.2% to 3%, of a polymer deposition aid. As used herein, “polymer deposition aid” refers to any cationic polymer or combination of cationic polymers that significantly enhance deposition of a fabric care benefit agent onto the fabric during laundering. Suitable polymer deposition aids can comprise a cationic polysaccharide and/or a copolymer. “Fabric care benefit agent” as used herein refers to any material that can provide fabric care benefits. Non-limiting examples of fabric care benefit agents include: silicone derivatives, oily sugar derivatives, dispersible polyolefins, polymer latexes, cationic surfactants and combinations thereof. Preferably, the deposition aid is a cationic or amphoteric polymer. The cationic charge density of the polymer preferably ranges from 0.05 milliequivalents/g to 6 milliequivalents/g. The charge density is calculated by dividing the number of net charge per repeating unit by the molecular weight of the repeating unit. In one embodiment, the charge density varies from 0.1 milliequivalents/g to 3 milliequivalents/g. The positive charges could be on the backbone of the polymers or the side chains of polymers.

Organic builder and/or chelant: The base mix can comprise from 0.6% to 10%, preferably from 2 to 7% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates such as Tiron™ and mixtures thereof.

Enzymes: Suitable enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, lipase, cutinase and/or cellulase in conjunction with amylase. Detersive enzymes are described in greater detail in U.S. Pat. No. 6,579,839.

Enzyme stabiliser: Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Optical brighteners: Also known as fluorescent whitenening agents for textiles are useful laundering adjuncts. Suitable use levels are from 0.001% to 1% by weight of the fluid laundry detergent composition. Brighteners are for example disclosed in EP 686691B and include hydrophobic as well as hydrophilic types. Brightener 36 and Brightener 49 are preferred for use herein.

Hueing dyes: Hueing dyes, shading dyes or fabric shading or hueing agents are useful laundering adjuncts in fluid laundry detergent compositions. The history of these materials in laundering is a long one, originating with the use of “laundry blueing agents” many years ago. More recent developments include the use of sulfonated phthalocyanine dyes having a Zinc or aluminium central atom; and still more recently a great variety of other blue and/or violet dyes have been used for their hueing or shading effects. See for example WO 2009/087524 A1, WO2009/087034A1 and references therein. The fluid laundry detergent compositions herein typically comprise from 0.00003 wt % to 0.1 wt %, from 0.00008 wt % to 0.05 wt %, or even from 0.0001 wt % to 0.04 wt %, fabric hueing agent.

Particulate material: Suitable particulate materials are clays, suds suppressors, encapsulated sensitive ingredients, e.g., perfumes, bleaches and enzymes in encapsulated form; or aesthetic adjuncts such as pearlescent agents, pigment particles, mica or the like. Suitable use levels are from 0.0001% to 5%, or from 0.1% to 1% by weight of the liquid detergent composition.

Perfume: Suitable perfumes are known in the art, and are typical incorporated at a level from 0.001 to 10%, preferably from 0.01% to 5%, more preferably from 0.1% to 3% by weight.

Cleaning polymers: Suitable cleaning polymers provide for broad-range soil cleaning of surfaces and fabrics and/or suspension of the soils. Any suitable cleaning polymer may be of use. Useful cleaning polymers are described in USPN 2009/0124528A1. Non-limiting examples of useful categories of cleaning polymers include: amphiphilic alkoxylated grease cleaning polymers; clay soil cleaning polymers; soil release polymers; and soil suspending polymers.

External structurant: Preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

### Methods:

### A) Method of Evaluating the Phase Stability of Fluid Laundry Detergent Compositions:

The phase stability of the composition is evaluated by placing 300 ml of the composition in a glass jar for up to a time period of 21 days at 25° C. They are stable to phase splits if, within said time period, (i) they are free from splitting into two or more layers or, (ii) said composition splits into layers, a major layer comprising at least 90%, preferably 95%, by weight of the composition is present.

### B) Method of Measuring Viscosity:

The viscosity is measured using an AR 2000 rheometer from TA instruments using a cone and plate geometry with a 40 mm diameter and an angle of 1°. The viscosity at the different shear rates is measured via a logarithmic shear rate sweep from 0.1 s⁻¹ to 1200 s⁻¹ in 3 minutes time at 20° C. Low shear viscosity is measured at a continuous shear rate of 0.05 s⁻¹.

### C) Turbidity (NTU):

The turbidity (measured in NTU: Nephelometric Turbidity Units) is measured using a Hach 2100P turbidity meter calibrated according to the procedure provided by the manufacture. The sample vials are filled with 15 ml of representative sample and capped and cleaned according to the operating instructions. If necessary, the samples are degassed to remove any bubbles either by applying a vacuum or using an ultrasonic bath (see operating manual for procedure). The turbidity is measured using the automatic range selection.

### D) Percentage of Liquid Crystalline Phase:

Product is prepared, without the presence of external structurants, and without particulates or other solids which do not dissolve in the product. The product sample is then put in storage in scaled centrifuge tubes for a minimum of 1 day at 5° C. and then centrifuged for 1 h at 4400 rpm. After centrifugation, the % liquid crystalline phase is measured as the height of the liquid crystalline phase with a ruler compared to the total height of the centrifuged sample.

### E) Method of Measuring pH:

The pH is measured, at 25° C., using a Santarius PT-10P pH meter with gel-filled probe (such as the Toledo probe, part number 52 000 100), calibrated according to the instructions manual.

### EXAMPLES

The following compositions were prepared:

| | 1 | 2 | 3 | 4 |
|---|---|---|---|---|
| | (compar- | (inven- | (compar- | (inven- |
| | ative) | tion) | ative) | tion) |
| | wt % | wt % | wt % | wt % |
| C12-14 alkyl | 10.1 | 10.1 | 7.1 | 7.1 |
| polyethoxylate (3.0) | | | | |
| sulfate | | | | |
| C12 linear | 10.4 | 10.4 | 8.4 | 8.4 |
| alkylbenzene | | | | |
| sulfonc acid | | | | |
| C12-14 alkyl 7- | — | — | 0.2 | 0.2 |
| ethoxylate | | | | |
| Citric Acid | — | — | 3.0 | 3.0 |
| C12-18 Fatty Acid | 4.1 | 4.1 | 2.9 | 2.9 |
| Zwitterionic | 0.0 | 0.9 | 0.0 | 0.6 |
| polyamine¹ | | | | |
| Diethylene Triamine | 0.5 | 0.5 | 0.4 | 0.4 |
| Penta Methylene | | | | |
| Phosphonic acid | | | | |
| PEG-PVAc Polymer² | — | — | 1.1 | 1.1 |
| Brightener 49 | — | — | 0.06 | 0.06 |
| Hydrogenated castor | — | — | 0.28 | 0.28 |
| oil | | | | |
| 1,2 propanediol | 0.0 | 0.0 | 1.1 | 1.1 |
| Calcium Chloride | — | — | 0.01 | 0.01 |
| Monoethanolamine | — | — | 0.2 | 0.2 |
| Sodium hydroxide | 1.9 | 1.9 | 3.2 | 3.2 |
| Acticide MBS2550 | — | — | 0.005 | 0.005 |
| Silicone suds | — | — | 0.0025 | 0.0025 |
| suppressor | | | | |
| Perfume | — | — | 0.8 | 0.8 |
| Dye | — | — | 0.003 | 0.003 |
| Water | to 100% | to 100% | to 100% | to 100% |
| Rheology (cps): | | | | |
| at 0.05/s | 11620 | 1798 | 43700 | 40440 |
| at 1/s | 9739 | 1220 | 3653 | 3176 |
| at 100/s | 1500 | 990 | 455 | 418 |
| at 1000/s | 160 | 474 | 328 | 312 |

¹Zwitterionic ethoxylated quaternized sulfated hexamethylene diamine, supplied by BASF, Germany
²Polyvinyl acetate grafted polyethylene oxide copolymer having a polyethylene oxide backbone and multiple polyvinyl acetate side chains, supplied by BASF, Germany.

As can be seen from comparative examples 1 and 3, formulating the laundry detergent compositions without ethanol resulted in high viscosities which would lead to processibility issues, an undesirable pour viscosity, and residues in the washing machine. As can be seen from examples 2 and 4, by adding a zwitterion, the resultant laundry detergent compositions have a viscosity profile which is processible, with a much more desirable pour profile, and would not result in residues remaining in the washing machine after use—even though the compositions do not contain any solvent.

The following compositions were prepared:

| | 7 | 8 |
|---|---|---|
| | wt % | wt % |
| C12-14 alkyl polyethoxylate | 7.1 | 1.8 |
| (3.0) sulfate | | |
| C12-15 linear alkylbenzene | 8.4 | 13.7 |
| sulfonc acid | | |
| C12-15 alkyl 8-ethoxylate | 0.2 | 0.2 |
| Citric Acid | 3.0 | 3.0 |
| C12-18 Fatty Acid | 2.9 | 2.9 |
| Zwitterionic polyamine¹ | 0.5 | 0.5 |
| Diethylene Triamine Penta | 0.4 | 0.4 |
| Methylene Phosphonic acid | | |
| Brightener 49 | 0.06 | 0.06 |
| 1,2 propanediol | 1.1 | 1.1 |
| Calcium chloride | 0.01 | 0.01 |
| Monoethanolamine | 0.2 | 0.2 |
| Sodium hydroxide | 3.2 | 3.2 |
| Acticide MBS2550 | 0.005 | 0.005 |
| Silicone suds suppressor | 0.0025 | 0.0025 |
| Perfume | 0.8 | 0.8 |
| Dye | 0.003 | 0.003 |
| Water | to 100% | to 100% |

The composition of example 7 was stable, with no phase-splitting even after centrifugation. In contrast, the composition of example 8 was not phase stable, with a clear separation of a surfactant-rich phase and a low surfactant phase.

Examples 9 to 12 are non-limiting embodiments of the present invention. Percentages are by weight unless otherwise specified.

| | 9 | 10 | 11 | 12 |
|---|---|---|---|---|
| | wt % | wt % | wt % | wt % |
| C12-14 alkyl polyethoxylate | 5.3 | 9.0 | 6.8 | 8.1 |
| (3.0) sulfate | | | | |
| C12-15 linear alkylbenzene | 18.0 | 6.8 | 12.0 | 8.4 |
| sulfonc acid | | | | |
| C12-15 alkyl 8-ethoxylate | 3 | 5 | 0.4 | 0.4 |
| Citric Acid | 1.0 | 4.0 | 2.0 | 1.0 |
| C12-18 Fatty Acid | 2 | 2.5 | 2.9 | 3.0 |
| NaCS | 0.5 | 0.3 | 0 | 0 |
| Zwitterionic polyamine¹ | 1.0 | 0.6 | 0.8 | 0.5 |
| Diethylene Triamine Penta | 0.4 | 0.3 | 0.35 | 0.25 |
| Methylene Phosphonic acid | | | | |
| Mannanase³ | 0.0015 | 0.003 | 0.0 | 0.0015 |
| Amylase⁴ | 0.004 | 0.008 | 0.0 | 0.006 |
| Protease⁵ | 0.02 | 0.05 | 0.0 | 0.03 |
| Cellulase⁶ | | | | |
| PEG-PVAc Polymer² | 1.5 | 2 | 1 | 2.5 |
| Brightener 49 | 0.08 | 0.05 | 0.1 | 0.04 |
| Hydrogenated castor oil | 0.2 | 0.28 | 0.3 | 0.15 |
| 1,2 propanediol | 3 | 2.5 | 0.5 | 2 |
| Sodium formate | 0.75 | 0.5 | 0 | 1 |
| Calcium Chloride | 0.01 | 0.02 | 0 | 0.03 |
| Monoethanolamine | 0.15 | 0.2 | 0.3 | 0.25 |
| Sodium hydroxide | to pH | to pH | to pH | to pH |
| | 7.90 | 7.70 | 8.30 | 7.80 |
| Acticide MBS2550 | 0 | 0.005 | 0.015 | 0.005 |
| Silicone suds suppressor | 0.005 | 0.0025 | 0.0025 | 0.0025 |
| Perfume microcapsules | 0.400 | 0.200 | 0 | 0.150 |
| Perfume | 1.5 | 0.8 | 0.5 | 0.6 |
| Dye | 0.003 | 0.01 | 0.001 | 0.002 |
| Water | to 100% | to 100% | to 100% | to 100% |

³Mannanase enzyme originating from Bacillus sp. I633 available from Novozymes, Denmark
⁴Termamyl ® Ultra, available from Novozymes, Denmark
⁵Protease enzyme from Bacillus Amyloliquefaciens as described in EP 0 130 756 B1 published Jan. 9, 1985
⁶Carezyme ® available from Novozymes, Denmark

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
a) a cleaning surfactant selected from the group consisting of: anionic surfactant, non-ionic surfactant, and mixtures thereof;
b) a zwitterion; and
c) less than about 2 wt % of organic, non-aminofunctional solvent.

2. The liquid detergent composition according to claim 1, wherein the cleaning surfactant is present at a level of from about 1 wt % to about 70 wt %.

3. The liquid detergent composition according to claim 1, wherein the cleaning surfactant comprises anionic surfactant, such that the level of anionic surfactant in the liquid detergent composition is present at a level of from about 1 wt % to about 50 wt %.

4. The liquid detergent composition according to claim 1, wherein the anionic surfactant comprises linear alkyl benzene sulfonate surfactant and alkyl alkoxylated sulphate surfactant, such that the ratio of linear alkyl benzene sulfonate surfactant to alkyl alkoxylated sulphate surfactant is from about 0.1 to about 5.

5. The liquid detergent composition according to claim 1, wherein the cleaning surfactant comprises non-ionic surfactant, such that the level of non-ionic surfactant in the liquid detergent composition is present at a level of less than about 10 wt %.

6. The liquid detergent composition according to claim 1, wherein the zwitterionic surfactant is present at a level of from about 0.1 wt % to about 5 wt %.

7. The liquid detergent composition according to claim 1, wherein the zwitterion is a zwitterionic polyamine, preferably having the formula: 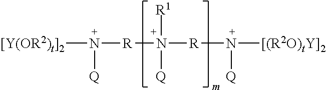
wherein R units are C₃-C₆ alkylene units, R¹ is hydrogen, Q, —(R²O)ₜY, and mixtures thereof, R² is ethylene, Y is hydrogen, an anionic unit selected from the group consisting of —(CH₂)_{f}CO₂M, —C(O)(CH₂)_{f}CO₂M, —(CH₂)_{f}PO₃M, (CH₂)_{f}OPO₃M, —(CH₂)_{f}SO₃M, —CH₂(CHSO₃M)(CH₂)_{f}SO₃M, —CH₂(CHSO₂M)(CH₂)_{f}SO₃M, and mixtures thereof; M is hydrogen, a water soluble cation, and mixtures thereof; the index f is from 0 to about 10; Q is selected from the group consisting of C₁-C₄ linear alkyl, benzyl, and mixtures thereof; the index m is from about 0 to about 20; the index t is from about 15 to about 25.

8. The liquid detergent composition according to claim 1, wherein the zwitterion is a zwitterion polymer which comprises a polyamine backbone, said backbone comprising two or more amino units wherein at least one of said amino units is quaternized and wherein at least one amino unit is substituted by one or more moieties capable of having an anionic charge wherein further the number of amino unit substitutions which comprise an anionic moiety is less than or equal to the number of quaternized backbone amino units.

9. The liquid detergent composition according to claim 1, wherein the liquid detergent composition comprises less than about 2 wt % of organic, non-aminofunctional solvent.

10. The liquid detergent composition according to claim 1, wherein the liquid detergent composition comprises less than about 0.8 wt % of an organic, non-aminofunctional solvent having a closed cup flash point (CCFP) of less than about 60° C., preferably less than about 38° C. measured according to the Pensky Martens closed cup flash point (CCFP) test, described in ASTM D93.

11. The liquid detergent composition according to claim 1, wherein the liquid detergent composition comprises less than about 1 wt % of a hydrotrope.

12. The liquid detergent composition according to claim 1, wherein the liquid detergent composition comprises a non-surfactant salt selected from the group consisting of: sodium carbonate, sodium hydrogen carbonate (sodium bicarbonate), magnesium chloride, ethylenediaminetetraacetic acid (EDTA), diethylene triamine pentaacetic acid (DTPA), hydroxyethane diphosphonic acid (HEDP), sodium citrate, sodium chloride, citric acid, calcium chloride, sodium formate, Diethylene triamine penta methylene phosphonic acid, and mixtures thereof.

13. The liquid detergent composition according to claim 1, wherein the liquid detergent composition comprises at least 10% of a liquid crystalline phase.

14. A method of use of a zwitterion for reducing the viscosity of a liquid detergent composition, whereby:
(a) a liquid detergent composition is formulated to comprise a worm-like micellar phase, or a liquid crystalline phase; and
(b) a zwitterion is added during the making, such that the viscosity of the liquid detergent composition is reduced.
